(19) United States
(12) Patent Application Publication
(10) Pub. No.: US 2010/0302067 A1
(43) Pub. Date: Dec. 2, 2010

(54) Dynamic parking place location system

(76) Inventors: Stuart O. Goldman, Scottsdale, AZ (US); Susan A. Feyerabend, Scotch Plains, NJ (US)

Correspondence Address: Docket Administrator - Room 3D-201E;Alcatel-Lucent USA Inc., 600-700 Mountain Avenue, Murray Hill, NJ, 07974, US

(21) Appl. No.: 12/455,130

(22) Filed: May 28, 2009

(51) Int. Cl. G08G 1/14

(52) U.S. Cl. 340/932.2

(57) ABSTRACT

A dynamic parking place location service is disclosed that can assist end users navigating a congested area to find available parking spaces near their location on-demand. An end user initiates a parking information request by contacting an application server and sending location information coincident to the request. Responsive to the request, the application server consults a database of parking space utilization information associated with one or more designated parking spaces and returns one or more candidate parking spaces for the end user at the end user location or projected location.

### FIELD OF THE INVENTION

This invention relates generally to transportation services and, more particularly to a service for providing parking place location information to end users.

### BACKGROUND OF THE INVENTION

Information-based services are well known in which an end user may access an information service, for example and without limitation, by calling a designated number (e.g., 1-800-number) or entering a URL (Uniform Resource Locator) from a PC or web-enabled phone to access an information resource corresponding to a particular topic, product or business on the Internet. Depending on the resource, the information content can be tailored to particular customers or locations, or the customers may be provided broad-based content and a means to focus or refine their search to more specific content, for example, via operator assistance or by DTMF-tone-driven menus in a telephony implementation or by navigating the Internet in a PC or web-enabled phone implementation.

Navigation equipment and services are also well known in which end users may access maps, driving directions and the like corresponding to particular locations or businesses, from a PC or web-enabled phone or via a dedicated GPS-based navigation unit carried on the person or vehicle.

Nevertheless, despite the wide range of information services and resources that are presently known, there is an unfulfilled need for a service to provide parking place location information for end users.

### SUMMARY OF THE INVENTION

This need is addressed and a technical advance is achieved in the art by a dynamic parking place location service that can be utilized to assist end users navigating a congested area to find available parking spaces near their location on-demand.

In one embodiment, the dynamic parking place location service comprises a data collection component and an application server component. The data collection component operates to detect and maintain parking space utilization information associated with one or more designated parking spaces at a particular location. The application server component operates to receive a parking information request from an end user, consult the parking space utilization information to determine one or more candidate parking spaces for the end user and communicate indicia of the candidate parking spaces to the end user. In one embodiment, the application server receives indicia of the end user location coincident to the parking information request and determines one or more nearest candidate parking spaces for the end user at that location.

In another embodiment, there is provided a method comprising receiving a parking information request from an end user; consulting parking space utilization information to determine one or more candidate parking spaces for the end user; and communicating indicia of the candidate parking spaces to the end user. The method may further comprise determining a location of the end user and determining the candidate parking spaces based at least in part on the end user location.

In another embodiment, there is provided an article comprising one or more computer-readable signal-bearing media; and means in the one or more media, responsive to receiving a parking information request from an end user, for determining a location of the end user and consulting parking space utilization information to determine one or more candidate parking spaces for the end user based at least in part on the user location.

In yet another embodiment, there is provided an article comprising one or more computer-readable signal-bearing media; and means in the one or more media, for sending a parking information request to an application server, the parking request including location information associated with an end user; and, responsive to sending the parking information request, receiving indicia of one or more candidate parking spaces for the end user based at least in part on the user location.

### BRIEF DESCRIPTION OF THE DRAWINGS

The foregoing and other advantages of the invention will become apparent upon reading the following detailed description and upon reference to the drawings in which:

FIG. 1 is a block diagram of a dynamic parking place location system according to an exemplary embodiment of the invention; and

FIG. 2 is a message sequence chart associated with a dynamic parking place location service according to an exemplary embodiment of the invention.

### DESCRIPTION OF THE PREFERRED EMBODIMENT(S)

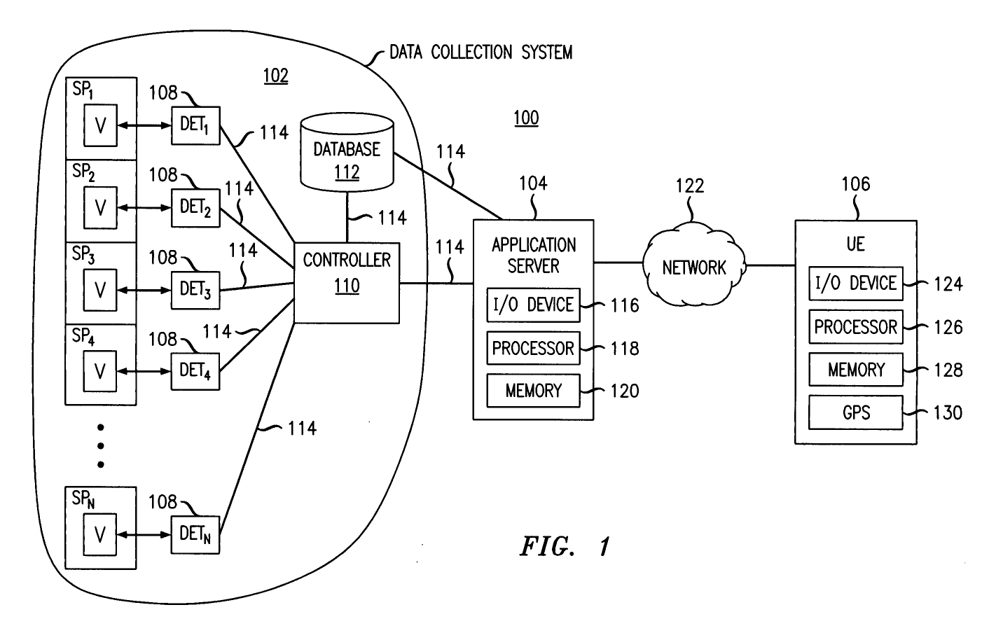

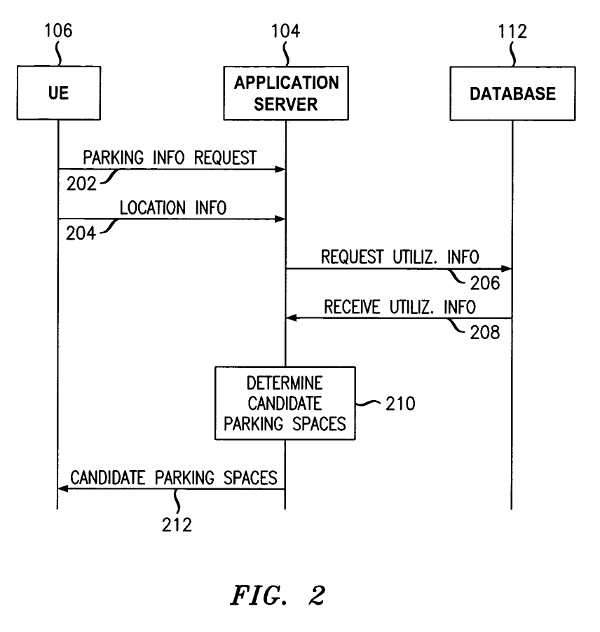

FIGS. 1-2 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a dynamic parking place location system 100 according to embodiments of the invention. The system 100 comprises a data collection system 102 and application server 104 operably connected to various end users 106 (one shown). According to embodiments of the invention, the system 100 is adapted to provide parking place location information to end users on demand (i.e., responsive to user requests).

The data collection system 102 comprises a plurality of detector platforms 108 (DET₁, . . . DETₙ) for monitoring a plurality of parking spaces (SP₁ . . . SPₙ) for parking space utilization information (e.g., the presence or absence of vehicles (V) or other blocking structures, and hence the availability or non-availability of the spaces for prospective end users) associated with the parking spaces. The detector platforms 108 may comprise generally any device or combination of devices presently known or devised in the future having the capacity to detect parking space utilization information associated with the parking spaces SP₁ . . . SPₙ. The detector platforms 108 may be utilized to monitor individual spaces or multiple spaces (i.e., the number of detector platforms 108 need not correspond exactly to the number of parking spaces).

For example and without limitation, the detector platforms 108 may comprise individually or collectively, one or more: ultrasonic proximity detectors, photo detectors, strain gauges for detecting the weight of vehicles or objects occupying the parking spaces, magnetometers for detecting metallic components of vehicles or objects, and so forth. Depending on the implementation and/or modality, the detector platforms 108 may be physically mounted in or adjacent to the various parking spaces, for example and without limitation, on a parking meter post or the like, or placed in the pavement or curb.

In one embodiment, the data collection system 102 includes a controller 110 for controlling and coordinating operation of the detector platforms 108 and to receive and process information received from the detector platforms 108. The controller forwards the parking place utilization information to a database 112. The database 112 stores parking place utilization information, and optionally may store location information, time-of-day information, parking restrictions, parking fee information or the like correlated with the parking place information. The database 112 may receive the information from the detector platforms 108, controller 110 or from external entities. As will be appreciated, the controller 110 and database 112 are functional elements that may reside individually or collectively in one or more physical structures or may be implemented in software. Optionally, the controller 110 and database 112 functionality may be distributed in whole or in part among one or more detector modules 108.

The data collection system 102 therefore detects parking space utilization information through operation of the detector platforms 108; the controller 110 coordinates operation and collects information from the detector platforms; and the database 112 maintains one or more records associated with the parking place utilization information. The detector platforms 108, controller 110, database 112 and application server 104 are connected by logical links 114 comprising, without limitation, wireline or wireless links.

The application server 104 receives and processes parking place information requests from end users 106. In one embodiment, responsive to the requests, the application server 104 consults the database 112 to determine one or more candidate parking spaces for the end users, and communicates indicia of the candidate parking spaces to the end user. In one embodiment, the application server receives indicia of end user location coincident to the parking information request, and determines one or more candidate parking spaces for the end user based at least in part on the end user location. As will be appreciated, the application server 104 is a functional element that may reside in one or more physical devices, separately from or residing within the elements of the data collection system 102.

For purposes of illustration, SP₁, SP₃, SP₄ and SPₙ are shown to be occupied by vehicles V, whereas SP₂ is vacant. Detector modules 108 will operate to detect the utilization status of SP₁, SP₃, SP₄ and SPₙ and indicia of the unoccupied status of space SP₂ (and optionally, indicia of occupied status of spaces SP₁, SP₃, SP₄ and SPₙ) will be forwarded to the database 112. Upon receiving a request from an end user 106 in the vicinity of spaces SP₁, SP₃, SP₄ and SPₙ, the application server will consult the database 112 to determine that SP₂ is vacant and may communicate indicia of the vacant space to the end user. Optionally, the application server may provide distances, travel times or the like to the available parking spaces.

When changes in utilization status occur, detector modules 108 will operate to detect the utilization status of SP₁, SP₃, SP₄ and SPₙ and so inform the database. In one embodiment, changes in utilization status are reported following a slight delay (e.g., on the order of seconds) such that when one vehicle pulls out and is rapidly replaced by another, the space is not reported as available and then quickly reported as unavailable.

As another option, the database 112, under control of the application server 104 or controller 110, may indicate an otherwise vacant spot as unavailable, at least temporarily, to avoid contention for a vacant spot from multiple end users. Thus, for example, when end user 106 is notified that space SP₂ is available, the end user might request to reserve that spot to allow time to locate and park in that spot. In such case, the database may assign a “reserved” status to space SP₂ such that it will not be reported as available to other end users. Thereafter, when space SP₂ becomes occupied (advantageously, by the end user 106 having received the parking place information), the detector modules 108 will detect and report the occupied status to the database 112. Optionally, time limits may be established for reserved spaces such that they may be returned to an available state if not already occupied after a reasonable time.

As shown, the application server 104 and the end users 106 are interconnected by a network 122. The network 122 comprises generally any network operable to pass information from the end users 106 to the application server 104 and vice versa. For example and without limitation, the network may comprise an IP Multimedia Subsystem (IMS) network, a wireless network (e.g., CDMA-based or GSM-based network), a circuit-switched network, a packet-based network (IP network) or another type of network.

The end user equipment (UE) 106 may comprise generally any device having capacity to request and receive information content from the application server 104 via network 122 comprising, for example and without limitation, a mobile phone, wireline phone, a PDA, VoIP phone or SIP phone, laptop or desktop computer. The UE 106 may employ user interfaces including, without limitation, numeric or alpha-numeric keypads, keyboards, text displays, audio-visual displays and the like to request and receive information content through network 122.

As shown, the application server 104 includes I/O devices 116, processor 118 and memory 120; and the UE 106 includes I/O devices 124, processor 126 and memory 128, plus a location module 130.

It should be understood that these devices are functional elements that may be implemented to perform any of the various functions of the application server 104 and UE 106. The term “I/O devices” as used herein is intended to encompass one or more communication modalities (e.g., without limitation, voice, data, text, e-mail) for communicating information/data between the end user 106 and application server 104 or external entities. The term “processor” as used herein is intended to include one or more processing devices, including a central processing unit (CPU) or other processing circuitry, including but not limited to one or more signal processors, one or more integrated circuits, and the like. The term “memory” as used herein is intended to include memory associated with a processor or CPU, such as RAM, ROM, a fixed memory device (e.g., hard drive), or a removable memory device (e.g., diskette or CDROM).

Accordingly, software instructions or code for performing the methodologies of the invention, described herein, may be stored in one or more of the associated memory devices, e.g., ROM, fixed or removable memory, and, when ready to be utilized, loaded into RAM and executed by the CPU. That is, the CPU may execute software instructions residing in computer-readable signal-bearing media of the application server 104 and UE 106, respectively, to perform steps associated with requesting and processing parking place information requests.

The location module 130 (as shown, “GPS” module) is a functional element for acquiring location information of the UE 106. For example and without limitation, the location module may comprise a GPS circuit for obtaining location data of the UE with assistance of the Global Positioning System satellite constellation. In one embodiment, the UE may transmit location information coincident to sending a parking information requests to the application server 104; and the application server may consider the UE location information to find one or more candidate parking spaces near the UE location.

Turning to FIG. 2, there is shown a message sequence chart associated with the dynamic parking place location system 100. In one embodiment, the message sequence involves communication between the UE 106 (“End User”) and Application Server 104 and between the Application Server 104 and the database 112 of the dynamic parking place location system 100. The message sequence may be implemented using I/O devices 116, processor 118 and memory of the Application Server; and I/O devices 124, processor 126, memory 128 and location module 130 of the UE. The message sequence may be implemented using communication modalities including, without limitation, voice, data, text, e-mail.

As shown, the UE 106 initiates the message sequence by sending a parking information request 202 to the application server 104. In one embodiment, the parking information request 202 comprises a request for parking information corresponding to the UE location; and the UE 106 sends location information 204 (e.g., obtained from the location module 130) coincident to or separately from the parking information request, so as to inform the application server of the UE's location. Optionally, the UE 106 may send multiple location information messages 204 as may be necessary to dynamically update the UE's location as it moves about. Alternatively or additionally, the UE 106 may send location information 204 that does not presently correspond to the UE location, for example and without limitation, to solicit parking information for a projected destination of the UE that does not presently correspond to the UE 106 location.

Responsive to receiving the parking information request 202 and location information message(s) 204, the application server sends a message 206 to the database 112 to request parking space utilization information associated with the UE location. The application server receives the parking space utilization information via message 208.

Based on the parking space utilization information from the database 112 and the location information associated with the UE 106, the application server 104 determines one or more candidate parking spaces for the end user at block 210; and via message 212, the application server provides notice to the end user of the candidate parking spaces. For example and without limitation, the application server may determine a nearest available candidate parking space to the UE location or, or may determine a plurality of candidate parking spaces in an ordered sequence based on proximity to the UE location or projected location. In one embodiment, the end user may select one of the candidate spaces to request a reservation; and the application server will hold the reservation for a limited time such as earlier described. As will be appreciated, the notice of candidate parking spaces may be supplemented with map data, driving directions or the like to facilitate ease of location of the candidate parking spaces.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. The invention may be deployed in generally any wireline, wireless or IMS network including those with network topologies that differ from FIG. 1 or that use message sequences other than shown in FIG. 2. The scope of the invention is, therefore, indicated by the appended claims rather than by the foregoing description. All changes that come within the meaning and range of equivalency of the claims are to be embraced within their scope.

What is claimed is:

1. A dynamic parking place location system comprising:
a data collection system operable to detect and maintain parking space utilization information associated with one or more designated parking spaces; and
an application server operably connected to the data collection system and one or more end users, the application server operable to receive a parking information request from an end user, consult the parking space utilization information to determine one or more candidate parking spaces for the end user, and communicate indicia of the candidate parking spaces to the end user.

2. The system of claim 1, wherein the application server receives coincident to the parking information request, indicia of the end user location, the application server determining the one or more candidate parking spaces for the end user based at least in part on the end user location.

3. The system of claim 2, wherein the data collection system comprises:
one or more detector modules for detecting the parking space utilization information; and
a database for storing the parking space utilization information.

4. The system of claim 3, wherein the detector modules include one or more of an ultrasonic proximity detector, strain gauge, photodector and magnetometer.

5. The system of claim 3, wherein the data collection system further comprises:
a controller operably connected to the detector modules and the database, the controller operable to receive the parking space utilization information from at least a portion of the detector modules and communicate the parking space utilization information to one or more of the database and application server.

6. A method comprising:
receiving a parking information request from an end user;
consulting parking space utilization information to determine one or more candidate parking spaces for the end user; and
communicating indicia of the candidate parking spaces to the end user.

7. The method of claim 6, further comprising:
determining a location of the end user;
determining the candidate parking spaces based at least in part on the end user location.

8. The method of claim 7, wherein the step of determining a location is accomplished coincident to receiving the parking information request, the parking information request including indicia of the user location.

9. The method of claim 7, wherein the step of determining the candidate parking spaces includes determining one or more closest available parking spaces relative to the user location.

10. An article comprising:
one or more computer-readable signal-bearing media; and
means in the one or more media, responsive to receiving a parking information request from an end user, for determining a location of the end user and consulting parking space utilization information to determine one or more candidate parking spaces for the end user based at least in part on the user location.

11. An article comprising:
one or more computer-readable signal-bearing media; and
means in the one or more media, for sending a parking information request to an application server, the parking request including location information associated with an end user; and, responsive to sending the parking information request, receiving indicia of one or more candidate parking spaces for the end user based at least in part on the user location.
